(19) United States
(12) Patent Application Publication
(10) Pub. No.: US 2011/0019573 A1
(43) Pub. Date: Jan. 27, 2011

(54) LOW COMPLEXITY USER SELECTION FOR SDMA

(75) Inventor: Doron Ezri, Tel Aviv (IL)

Correspondence Address: ROBERT G. LEV, 4766 MICHIGAN BLVD., YOUNGSTOWN, OH, 44505, US

(73) Assignee: Runcom Technologies Ltd., Rishon Lezion (IL)

(21) Appl. No.: 12/920,642

(22) PCT Filed: Mar. 3, 2009
(86) PCT No.: PCT/IB09/50855

§ 371 Date: Sep. 2, 2010

Related U.S. Application Data
(60) Provisional application No. 61/033,033, filed on Mar. 3, 2008.

(51) Int. Cl. H04L 12/26; H04W 4/00

(52) U.S. Cl. 370/252; 370/328

(57) ABSTRACT

A method for grouping terminal devices in a wireless communication network containing a base-station, wherein each terminal reports to the base-station the level of signal received the terminal when the base-station transmits to another terminal or terminals. The base-station then selects from the plurality of the terminals, groups of terminals indicating low signal measurements for data transmissions sent to other group members of the group.

### CROSS-REFERENCE TO RELATED APPLICATIONS

The present application claims priority from U.S. provisional patent application 61/033,033, filed Mar. 3, 2008, the contents of which are hereby incorporated by reference.

### FIELD AND BACKGROUND OF THE INVENTION

The invention relates to wireless communication system and methods and, more particularly, but not exclusively to a systems and methods for space division multiple access.

Space division multiple access (SDMA) is a wireless communication method known in the art. SDMA enables a transmitter to transmit several and different data streams to several receivers, concurrently, using the same frequency and time resources. This is done by pointing each data stream to its target receiver in a way that other receivers do not receive data streams that are not intended for them. To achieve this goal the communication area is spatially divided between the receivers and the transmitter communicates concurrently with those receivers that are appropriately positioned in respective space divisions.

Practically, in the downlink (DL), SDMA is an advanced multiple input—multiple output (MIMO) transmission method in which a base-station transmits multiple beamformed streams of independent information to multiple user terminals simultaneously, using the same frequency and time resources. A typical MIMO system contains an antenna array, which contains several antenna elements. The transmitter uses the antenna array to create a plurality of beams, where each beam is directed to an appropriate receiver and carries a respective data stream. The beams are typically designed for minimal multi-user interference, which means that the beam conveying the information to the i-th receiver approximately nulls out at the direction of all other active receivers (null steering). The following U.S. patents and patent applications are believed to represent the most relevant prior art: 20070223423, 20070109630, 20060040672, 20030064754,U.S. Pat. Nos. 7,299,073, 7,206,293, 6,973,314, 6,650,881, 6,441,784.

Typically, the number of receivers with which an SDMA system can communicate concurrently in a given time is smaller than the number of receivers in the reception area. Thus, the base-station should determine which of the receivers should participate in a group of concurrent transmissions. The base-station therefore divides the receivers into several groups where members of each group can receive concurrent data streams.

In a mobile communication system, the location of the receivers changes rapidly. Thus, the base station must compute the groups' membership frequently. Given the large number of combinations of group memberships, the computational load is very high, adversely affecting the practical usability of the SDMA technology. There is thus a widely recognized need for, and it would be highly advantageous to have, an SDMA system devoid of the above limitations.

### SUMMARY OF THE INVENTION

According to one aspect of the invention there is provided a method for selecting a group of terminal devices from a plurality of terminal devices; wherein the plurality of terminal devices is operative in a wireless communication network containing at least one transmitter operative to communicating with a multiplicity of terminal devices from the plurality of terminal devices; and wherein the transmitter is operative to transmit a beamformed plurality of concurrent data transmissions oriented at the selected group of terminal devices. The method containing the steps of:

measuring radiated power received by the terminal devices when a beamformed data transmission is sent by the transmitter to at least one another terminal device, wherein the measuring of radiated power forms channel correlation measurement;

reporting the channel correlation measurement to the transmitter; and

selecting, at the transmitter, the group of terminal devices from the multiplicity of terminal devices, wherein the group consists of terminal devices reporting low channel correlation with all other terminal devices in the group.

According to another aspect of the invention there is provided a method for selecting a group of terminal devices from a plurality of terminal devices wherein the beamformed plurality of concurrent data transmissions forms a group of beams, each directed towards at least one terminal device of a the selected group of terminal devices.

According to yet another aspect of the invention there is provided a method for selecting a group of terminal devices from a plurality of terminal devices wherein the transmitter is a base-station.

According to still another aspect of the invention there is provided a method for selecting a group of terminal devices from a plurality of terminal devices wherein the channel correlation measurement contains at least one of:
a measurement value of signal power received at the terminal devices when a beamformed data transmission is sent by the transmitter to at least one another terminal device;
an indication that the signal power received at the terminal devices when a beamformed data transmission is sent by the transmitter to at least one another terminal device is below a predefined value;
an indication that the signal power received at the terminal devices when a beamformed data transmission is sent by the transmitter to at least one another terminal device is above a predefined value;
an identification of the another terminal device; and
an identification of a time-frequency slot in which the data transmission was sent by the transmitter to the another terminal device;

Further according to another aspect of the invention there is provided a first terminal device operative in a wireless network, the wireless network containing a base-station and a plurality of terminal devices, the first terminal device containing:
a receiver unit operative to receive transmissions from the base-station;
a power measuring unit operative to measure radiated power received by the first terminal device to form power measurement; and
a transmitter unit operative to transmit reception characteristics feedback to the base-station;

wherein the reception characteristics feedback contains at least one of a group containing:
a measurement of radiated power received at the first terminal device when the base-station transmits a beamformed transmission to at least one another terminal device;
an identification of at least one another terminal device for which the power measurement being less than a predefined value; and
an identification of a transmission slot for which the power measurement being less than a predefined value.

Yet further according to another aspect of the invention there is provided a base-station operative in a wireless network, the wireless network containing a plurality of terminal devices, the base-station containing:
a receiver unit operative to receive at least one reception characteristics feedback from the terminal devices; and
a transmitter unit operative to transmit beamformed data to the terminal devices according to the reception characteristics feedback;

wherein the reception characteristics feedback contains at least one of a group containing:
a measurement of radiated power received the plurality of terminal devices when the base-station transmits a beamformed transmission to at least one another terminal device;
an identification of at least one another terminal device for which the measurement of radiated power being less than a predefined value; and
an identification of a transmission slot for which the measurement of radiated power is less than a predefined value.

Still further according to another aspect of the invention there is provided an integrated circuit device for use in a first terminal device, the first terminal device operative in a wireless network, the wireless network containing a base-station and a plurality of terminal devices, the integrated circuit device containing:
a power measuring unit operative to measure radiated power received by the first terminal device to form power measurement; and
an output unit operative to provide reception characteristics feedback to a transmitter for transmitting the reception characteristics feedback to the base-station;

wherein the reception characteristics feedback contains at least one of a group containing:
a measurement of radiated power received at the first terminal device when the base-station transmits a beamformed transmission to at least one another terminal device;
an identification of at least one another terminal device for which the power measurement being less than a predefined value; and
an identification of a transmission slot for which the power measurement being less than a predefined value.

Even further according to another aspect of the invention there is provided an integrated circuit device for use in a base-station, the base-station operative in a wireless network, the wireless network containing a plurality of terminal devices, the integrated circuit device containing:
a receiver module operative to receive transmissions of reception characteristics feedback from the terminal devices, wherein the reception characteristics feedback contains at least one of:
   a measurement of radiated power received the plurality of terminal devices when the base-station transmits a beamformed transmission to at least one another terminal device;
   an identification of at least one another terminal device for which the measurement of radiated power being less than a predefined value; and
   an identification of a transmission slot for which the measurement of radiated power being less than a predefined value; and
a correlation module operative to select, from the plurality of terminal devices, at least one group of terminal device group members, wherein the reception characteristics feedback received from the group members indicate low radiated power for data transmissions sent by the base-station to other group members.

Additionally according to another aspect of the invention there is provided a computer program product, stored on one or more computer-readable media, containing instructions operative to cause a programmable processor of a first terminal device, the first terminal device operative in a wireless network, the wireless network containing a base-station and a plurality of terminal devices, the computer program product containing:
a power measuring module operative to monitor radiated power received by the first terminal device when the base-station transmits a beamformed transmission to at least one another terminal device and is additionally operative to perform at least one of:
   calculate power measurement for the radiated power received by the first terminal device;
   identify the another terminal device associated with the radiated power received by the first terminal device; and
   identify a transmission slot associated with the radiated power received by the first terminal device; and
an output module operative to provide reception characteristics feedback to a transmitter for transmitting the reception characteristics feedback to the base-station;

wherein the reception characteristics feedback contains at least one of:
measurement of radiated power received at the first terminal device;
identification of at least one another terminal device for which the power measurement being less than a predefined value; and
identification of a transmission slot for which the power measurement being less than a predefined value.

Also according to another aspect of the invention there is provided a computer program product, stored on one or more computer-readable media, containing instructions operative to cause a programmable processor of a base-station operative in a wireless network, the wireless network containing a plurality of terminal devices, the computer program product containing:
a receiver module operative to receive transmissions of reception characteristics feedback from the terminal devices, wherein the reception characteristics feedback contains at least one of:
   measurement of radiated power received by the plurality of terminal devices when the base-station transmits a beamformed transmission to at least one another terminal device;
   identification of at least one another terminal device for which the measurement of radiated power being less than a predefined value; and
   identification of a transmission slot for which the measurement of radiated power being less than a predefined value; and
a correlation module operative to select, from the plurality of terminal devices, at least one group of terminal devices, wherein the reception characteristics feedbacks received from members of the group of terminal devices indicate low radiated power for data transmissions sent by the base-station to other members of the group of terminal devices.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the invention involves performing or completing certain selected tasks or steps manually, automatically, or any combination thereof. Moreover, according to actual instrumentation and equipment of embodiments of the method and system of the invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A, 1B, 1C and 1D are simplified illustrations of four configurations of cross-terminal-feedback in an SDMA network;

FIGS. 2A and 2B are two simplified illustrations of two groups grouped by a base-station according to the cross-terminal-feedback;

FIG. 3 is a simplified block diagram of a cross-terminal-feedback generator circuitry forming part of a user-terminal in the SDMA network;

FIG. 4 is a simplified block diagram of a cross-terminal-feedback analyzer circuitry forming part of the base-station in SDMA network;

FIG. 5 is a simplified flow chart of a cross-terminal-cross-terminal-feedback software program for the cross-terminal-feedback generator circuitry of the user-terminal; and

FIG. 6 is a simplified flowchart of grouping software program for the cross-terminal-feedback analyzer circuitry of the base-station.

### DETAILED DESCRIPTION OF THE INVENTION

The invention, in embodiments thereof, comprises a system and method for cooperation between network devices in a wireless communication network. The wireless communication network uses space diversity multiple access technology (SDMA) and the cooperation enables the creation of at least one group of network devices. The grouping enables an SDMA transceiver to communicate with the members of the group concurrently, using the same frequency and time resources. The present embodiments comprise a low complexity user selection for SDMA groups in the wireless communication network. The principles and operation of a system and method for low complexity user selection for SDMA groups according to the invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

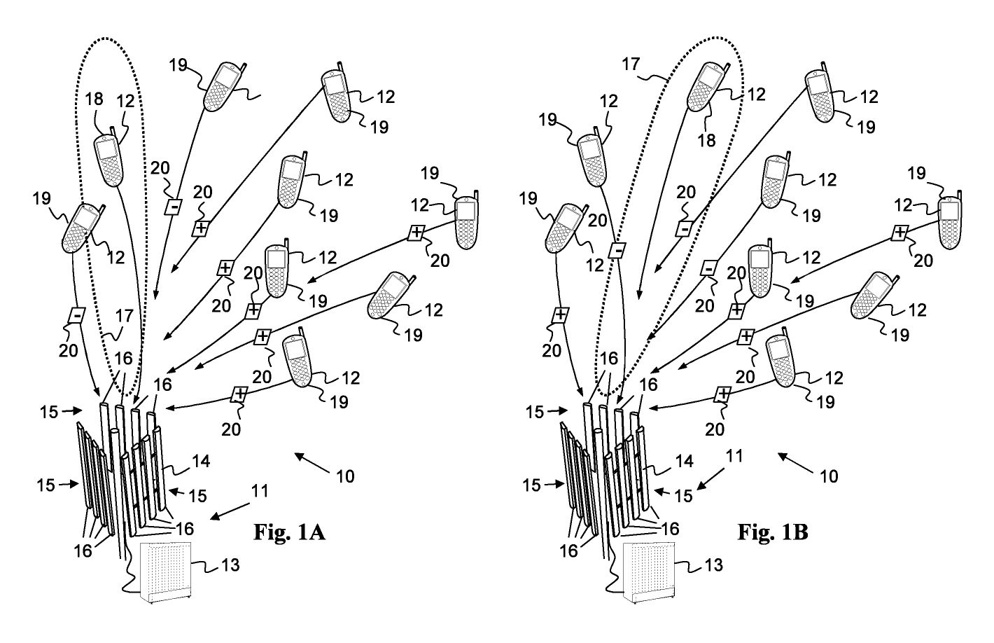

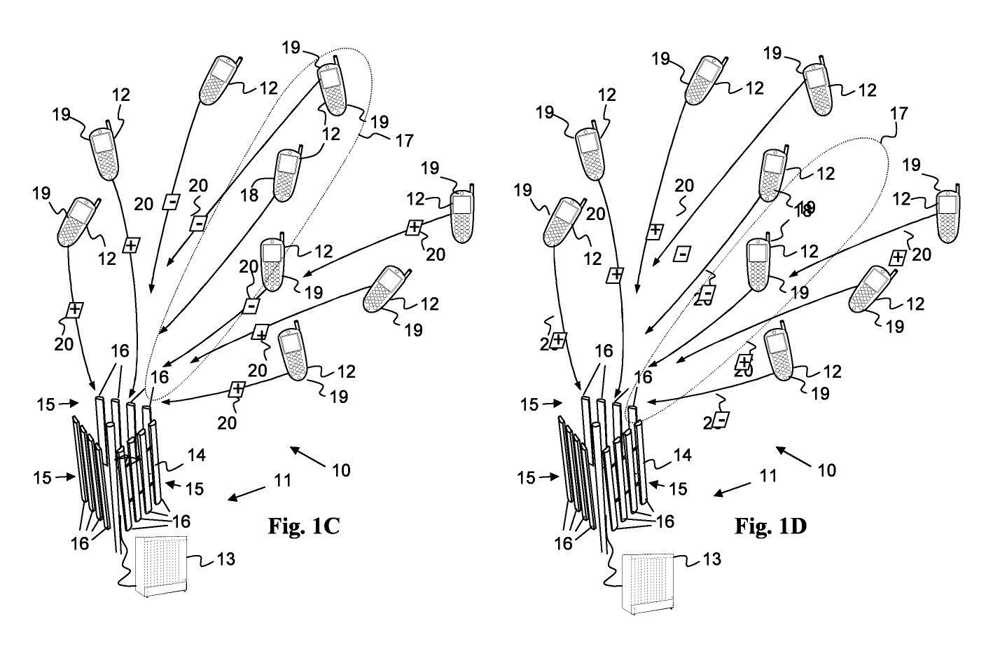

Reference is now made to FIGS. 1A, 1B, 1C and 1D which are simplified illustrations of four cross-terminal-feedback configurations in an SDMA network 10, according to a embodiment of the invention.

As seen in FIG. 1A, the SDMA network 10 preferably includes a base-station 11 and a plurality of user terminals 12. Preferably, the base-station 11 contains a transceiver unit 13 connected to a multiple-input—multiple-output (MIMO) antenna system 14. The MIMO antenna system 14 preferably includes three sectors 15, where each sector contains four antenna elements 16. Thus, each sector of the base-station 11 can produce a beamformed radiation containing up to four independent streams. It is appreciated that the numbers of three sectors and/or four antenna elements are provided as an example and other configurations are possible as known in the art.

As seen in FIG. 1A, the base-station 11 radiates a single beam 17 that is directed towards a user terminal 12 designated by numeral 18.

It is appreciated that though the SDMA network 10 of FIGS. 1A, 1B, 1C and 1D is a cellular telephone network, other types of wireless networks are possible. It is appreciated that the SDMA network 10 can contain a base station as seen in FIGS. 1A, 1B, 1C and 1D, or contain user terminals only, provided that at least one user terminal contains a MIMO antenna system, thus performing in a similar manner to the base-station 11.

As seen in FIG. 1A, the user terminals 12 designated by numeral 19 preferably transmit a cross-terminal-feedback information 20 to the base-station 11. Preferably, the user terminals 12 transmit the cross-terminal-feedback information 20 in response to a cross-terminal-feedback request (not shown in FIGS. 1A, 1B, 1C and 1D) from the base-station 11. Alternatively, the user terminals 12 may initiate the transmission of the cross-terminal-feedback information 20 without a request from the base-station 11. For example, a user terminal 12 may initiate a transmission of feedback-information 20 when entering coverage area of the base-station 11 or when moving about the coverage area so that reception conditions change. Preferably, the user-terminals 19 are all user terminals 12 except for the user-terminal 18, to which the beam 17 is directed.

The feedback-information 20 preferably contains channel correlation information. The channel correlation information indicates to the base-station 11 the reception level at the reporting user terminal 12 for a signal transmitted to a destination terminal. In the example of FIG. 1A, the destination terminal is user terminal 18 and the reporting terminals are user terminals 19.

As seen in FIG. 1A, each of the reporting terminals 19 sends feedback-information 20 to the base-station 11 to notify the base-station 11 if it is appropriate or inappropriate to group the reporting user terminal with the destination user terminal 18. As seen in FIG. 1A, a feedback-information 20 signifying an appropriate situation is designated by “+”, and a feedback-information 20 signifying an inappropriate situation is designated by “−”.

As seen in FIGS. 1A, 1B, 1C and 1D, the base-station 11 preferably scans the plurality of user terminals 12 by directing beamformed transmissions, such as beam 17, to all or to some of the user terminals 12. Preferably, the base-station 11 directs the beamformed transmission, such as beam 17, to the user terminals 12 one by one and collects feedback-information 20 from the rest of the user terminals 12. Preferably, the base-station 11 scans the plurality of user terminals 12 until the base-station 11 collects enough feedback-information 20 to create appropriate groups of user terminals 12.

The mathematical model for the received signals in an SDMA system such as the SDMA network 10 is provided below. It is assumed that M is the number of transmission antennas, for example at the base-station 11. It is also assumed that N is the number of reception antennas. In the examples herein, the N reception antennas belong to a group of user terminals 12 where each user terminal 12 contains one reception antenna. The number of transmission antennas M is equal or larger than the number of reception antennas N. The received signal at a reception antenna is then given by Eq. (1):

y=HWs+ρn where:

y is the value of signal received at a reception antenna;

s is the value of signal transmitted by a transmission antenna;

H is channel matrix;

W is precoding matrix, also known as beamforming matrix;
ρp is noise factor; and

n is white noise vector.

Therefore, sᵢ is the information signal transmitted by the base-station 11 to the i-th user terminal 12, and the signal yᵢ is the corresponding signal received at the antenna of the i-th user terminal 12.

In the SDMA network 10, each user terminal 12 uses its single antenna to reconstruct the single information stream addressed to it. Thus, the precoding matrix W has to be devised such that HW is diagonal or nearly diagonal. Otherwise, multi-user interference (MUI) is introduced.

Assuming that the SNR is high and MUI is the main concern, the beamforming matrix W satisfies Eq. (2):

HW=αD

where:

D is a diagonal matrix, and

α is a scaling factor.

The precoding matrix W also meets the unity power constraint as described by Eq. (3):

E∥Ws∥=1 and thus Eq. (4):

||W||²_{F}=1.
Thus, a straightforward solution meeting both requirements is the Zero Forcing (ZF) beamformer matrix W described by Eq(5):

$$W = \frac{H + D}{{‖ H + D ‖}_{F}}$$

The physical interpretation of SDMA implies that for the i-th receiver, an SDMA transmitter uses wᵢ, which creates a beam that amplifies sᵢ at the direction of that receiver, and attenuates sᵢ at the directions of all other N−1 receivers (spatial nulls). Eq. (5) for the SDMA beamforming matrix W also implies that an array of M transmission antennas can create up to M−1 nulls.

Typically, a base-station containing M antennas communicates with Nᵤ user terminals. Typically, Nᵤ>>M and therefore the base-station cannot use SDMA technology to transmit simultaneously to all the user terminals 12. Thus, when SDMA transmission is employed, the base-station has to divide the user-terminals into groups of N_{G} users where N_{G}≦M . The base station can then use SDMA technology to transmit simultaneously to all the N_{G} user terminals in a group G.

In the example described in accordance with FIGS. 1A, 1B, 1C and 1D, the base-station 11 preferably includes a MIMO antenna system 14 containing four antenna elements (in each sector) and therefore can communicate concurrently with up to four user-terminals 12. Therefore, preferably, the base-station 11 should divide the plurality of user-terminals 12 into groups of up to 4 user-terminals 12 in each group.

One way to divide user-terminals into groups would select user-terminals with orthogonal channel vectors into the same group. In this case, maximal ratio transmission (MRT) may be applied to each user-terminal independently, and no MUI is introduced (due to the orthogonal channels). In this case, MRT would also be the optimal solution. It is appreciated that in real scenarios perfect orthogonality cannot be found, and therefore groups of user-terminal with minimal correlation are desirable. This user-terminal selection algorithm implies exhaustive search and is thus difficult to realize. The purpose of the invention is to avoid this exhaustive search.

It is appreciated that not all user terminals 12 must transmit feedback-information 20 in response to each feedback request from the base-station 11. It is also appreciated that not all user terminals 12 must transmit feedback-information 20 in response to any number of feedback requests from the base-station 11. It is further appreciated that not all user terminals 12 must be grouped to enable base-station 11 to operate in an SDMA network 10. It is therefore appreciated that an SDMA network 10 can include only some of the user terminals 12 in groups, and other user terminals 12 as individual receivers. It is also appreciated that groups may include different numbers of user terminals 12. It is further appreciated that a user terminal 12 can be member in more than one group, for example to increase throughput to the user terminal 12.

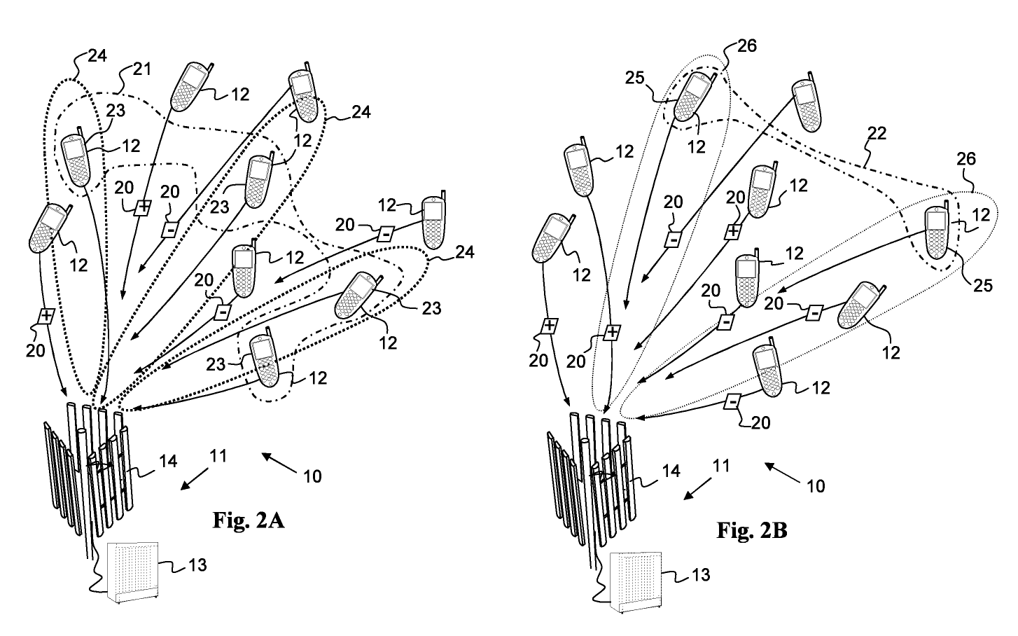

Reference is now made to FIGS. 2A and 2B, which are two simplified illustrations of Groups 21, and 22, respectively, of user-terminals 12, as grouped by the base-station 11 in the SDMA network 10, according to a embodiment of the invention.

As seen in FIG. 2A, four user-terminals 12, designated by numeral 23, are preferably grouped into group 21. The base-station 11 preferably produce an SDMA beamformed radiation containing three beamformed data-streams 24, respectively directed to the user-terminals 23 and containing four independent data streams.

As seen in FIG. 2B, two user-terminals 12, designated by numeral 25, are preferably grouped into group 22. The base-station 11 preferably produce an SDMA beamformed radiation containing two beamformed data-streams 26, respectively directed to the user-terminals 25 and containing two independent data streams.

As described in accordance with FIGS. 1A, 1B, 1C, 1D, 2A and 2B, in the SDMA network 10, the user-terminals 12 provide the base-station 11 with information required for grouping the user-terminals 12, thus enabling the base-station 11 to use a selection algorithm avoiding an exhaustive search. The user-terminals 12 provide the grouping information preferably by sending the feedback-information 20. The feedback-information 20 preferably contains information regarding the correlation between channels. To evaluate channel correlation, the user-terminals 12 preferably measure the signal power at their respective reception antennas when the base-station 11 transmits an SDMA beamformed transmission to other user terminals.

For example, the i-th user-terminal, such as user-terminal 18 of FIG. 1A measures the signal power at its reception antenna when the base-station 11 transmits an SDMA beamformed transmission to all other N−1 user-terminals 12, such as user-terminals 19 of FIG. 1A.

Hence, when the base-station 11 transmits an SDMA beamformed transmission to the j-th user-terminal (e.g. user-terminal 18 of FIG. 1A) all other N−1 user-terminals 12, such as user-terminals 19, obtain information regarding the correlation between channels.

This signal power is then used as an estimation of the channel correlation. The signal power, or a derivative of the signal power, is sent to the base-station 11 as a part of the feedback-information 20.

The beamformed signal to the i-th user-terminal is described by Eq(6):

$${Tx}_{i} = \frac{{h}_{i}^{*}}{‖ h , ‖} {s}_{i}$$

Therefore, the received signal at the j-th user-terminal, which is, for example, one of the user-terminals 19 of FIG. 1A, is described by Eq(7):

$${Rx}_{i} = {h}_{j} {Tx}_{i} + ρ {n}_{j} = \frac{{h}_{j} {h}_{i}^{*}}{‖ {h}_{j} ‖} {s}_{i} + ρ {n}_{j}$$

Hence, the channel correlation is obtained at the N−1 user terminals, which are for example, all user-terminals 19 of FIG. 1A.

Therefore, channel correlation is obtained for all user-terminals 19. Thus each user-terminal 19 can select the other user-terminals in its SDMA group according to the strength of the beamformed signal addressing the user-terminal 18 measured at its reception antenna. Once a suitable user-terminal is found (one received with low strength implying low correlation), the j-th user-terminal send to the base-station 11 feedback-information 20 containing a pointer to the allocation.

It is appreciated that the feedback-information 20 can indicate the channel correlation in a number of alternative ways. For example, the feedback-information 20 can contain the received signal power as measured, or an indication of the level of the received signal power, for example, with respect to a threshold level of signal power, or a predetermined set of signal levels. Alternatively or additionally, the feedback-information 20 can contain an identification of the terminal for which the received signal power was measured. Alternatively or additionally, the feedback-information 20 can contain an identification of the time slot at which the received signal power was measured.

Hence, as the base-station 11 scans the plurality of user-terminals 12, as shown in the sequence of FIGS. 1A, 1B, 1C, 1D, the base-station 11 receives from each of the user-terminals 12 the group of user-terminals it prefers (if such exist)

This approach may be extended to SDMA transmissions, where each transmission is composed of multiple beams towards multiple user-terminals in an SDMA group. Assuming that the channel correlation within the group is low, the transmitted SDMA signal Tx may be approximated by the sum of MRT beamformers depicted by Eq(8):

$$Tx = \frac{1}{K} \sum \frac{{h}_{i}^{*}}{‖ {h}_{i} ‖} {s}_{i}$$

where K is the number of beams or user terminals 12 with to the base station 11 transmits concurrently over the MIMO system, such as user terminals 23 of FIG. 2A.

Therefore, the received signal Rx at the reception antenna of the j-th user-terminal is presented by Eq(9):

$${Rx}_{j} = {h}_{i} Tx + ρ {n}_{j} = \frac{1}{K} \sum \frac{{h}_{j} {h}_{i}^{*}}{‖ {h}_{i} ‖} + ρ {n}_{j}$$

In this case, the strength of the measured signal at the Rx antenna of the j-th user-terminal reflects its channel correlation with all the SDMA group members (the average correlation). If this strength is low, the user-terminal may join the SDMA group.

It is appreciated that for SDMA systems where a user-terminal contains a plurality of Rx antennas the user-terminal measures the strength of the beamformed signal at each of its Rx antennas.

Thus, the wireless communication network includes a plurality of network devices, of which at least one network device is an SDMA transceiver that contains a plurality of antennas forming an antenna array. The network devices of this communication network cooperate to enable the SDMA transceiver to create at least one group of other network devices. The SDMA transceiver can then create a set of beamformed data streams wherein each data stream is directed to one member of the group, such as beamformed data streams 24 of FIG. 2A and beamformed data streams 25 of FIG. 2B. Thus, the SDMA transceiver communicates concurrently with all members of the group, using the same frequency and time resources.

It is appreciated that a beamformed data stream can address two or more user-terminals 12 as shown in FIG. 2A.

As seen in FIGS. 2A and 2B, the user-terminals 12 that are not part of the respective groups 21 and 22 are preferably sending feedback-information 20. This feedback-information 20 typically carries channel correlation information pertaining to the beamformed data streams 24 and 26, respectively. Hence, if user-terminals 12 move, or if new user-terminals 12 enter, the feedback-information 20 enable the base-station 11 to reevaluate the distribution of the user-terminals 12 and recreate the groups.

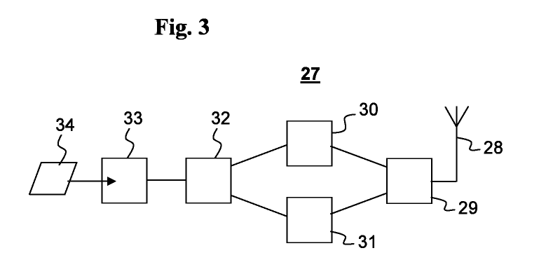

Reference is now made to FIG. 3, which is a simplified block diagram of a cross-terminal-feedback generator circuitry 27 forming part of user-terminal 12 in SDMA network 10 according to a embodiment of the invention.

As seen in FIG. 3, the user-terminal 12 preferably contains the following parts:
an antenna 28;
an antenna circuitry 29 connected to the antenna 28;
a receiver unit 30 connected to the antenna circuitry 29;
a transmitter unit 31 also connected to the antenna circuitry 29;
a received signal measuring unit 32 preferably connected to both the receiver unit 30 and the transmitter unit 31; and
a memory unit 33 connected to the received signal-measuring unit 32.

Preferably, the received signal-measuring unit 32 measures, via the receiver unit 30 and the antenna circuitry 29, the signal Rx received at the antenna 28. The received signal measuring unit 32 then calculates the cross-terminal-feedback 20 and transmits the cross-terminal-feedback 20 to the base-station 11 via the via the transmitter unit 31, the antenna circuitry 29 and the antenna 28.

The received signal measuring unit 32 preferably contains a microprocessor, and the memory unit 33 preferably contains storage area and cross-terminal-feedback software program 34 containing instructions for the processor of the received signal measuring unit 32.

Alternatively, the received signal measuring unit 32 can be implemented in hardware, such as by using a programmed gate array, for example by using a field programmable gate array (FPGA).

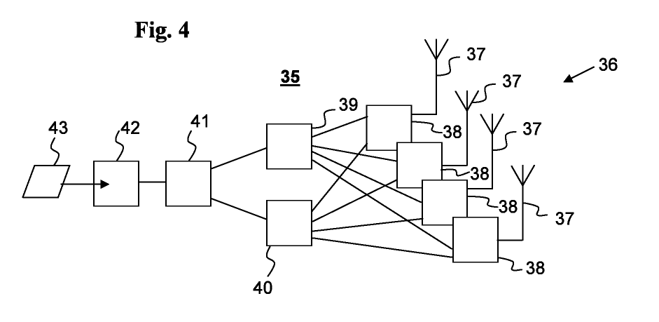

Reference is now made to FIG. 4, which is a simplified block diagram of a cross-terminal-feedback analyzer circuitry 35 forming part of base-station 11 in SDMA network 10 according to a embodiment of the invention.

As seen in FIG. 4, the base-station 11 preferably contains the following parts:
at least one antenna array 36, preferably forming a sector antenna array, preferably containing a plurality of antenna elements 37, such as antenna elements 16 of FIG. 1A;
a plurality of antenna circuitry units 38, each connected an antenna 37;
a receiver unit 39 connected to the antenna circuitry units 38;
a transmit beamforming unit 40 also connected to the antenna circuitry units 38;
a group correlating unit 41 preferably connected to both the receiver unit 39 and the transmit beamforming unit 40; and
a memory unit 42 connected to the group-correlating unit 41.

Preferably, the group-correlating unit 41 receives cross-terminal-feedback 20 from the receiver unit 39. The group-correlating unit 41 then analyzes the cross-terminal-feedback 20 to create groups of user-terminal 12. The group correlating unit 41 then instructs the transmit beamforming unit 40 to create beamformed transmissions to the user-terminal 12 forming each group.

The transmit beamforming unit 40 preferably contains a microprocessor, and the memory unit 42 preferably contains storage area and grouping software program 43 containing instructions for the processor of the transmit beamforming unit 41.

Alternatively, the transmit beamforming unit 40 can be implemented in hardware, such as by using a programmed gate array, for example by using a field programmable gate array (FPGA).

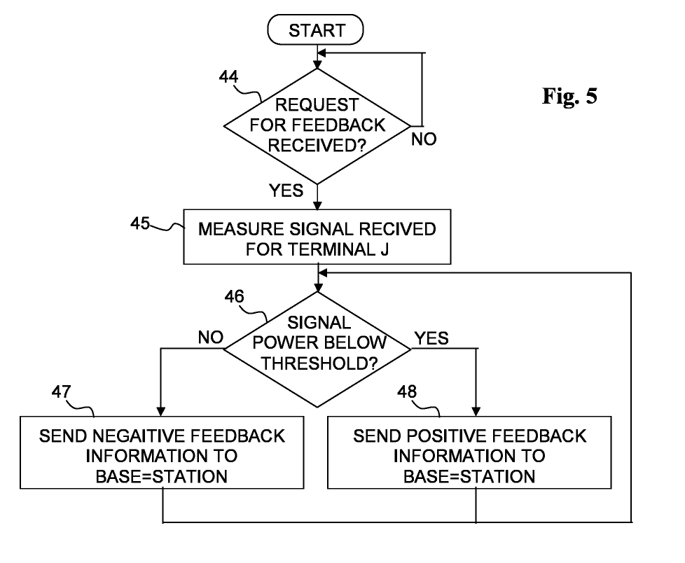

Reference is now made to FIG. 5, which is a simplified flow chart of the cross-terminal-feedback software program 43 according to a embodiment of the invention.

The cross-terminal-feedback software program 43 preferably starts in step 44 when the user-terminal 12 receives a request for cross-terminal-feedback from the base-station 11.

The cross-terminal-feedback software program 43 preferably proceeds to step 45 to measure the signal received at the reception antenna of the user-terminal 12 when the base-station 11 transmits to another user-terminal 12, herein designated as terminal J, such as user-terminal 18 of FIG. 1.

Alternatively, the cross-terminal-feedback software program 43 starts automatically in step 45.

The cross-terminal-feedback software program 43 preferably proceeds to step 46 to analyze the measured signal. Preferably, the cross-terminal-feedback software program 43 compares the signal level to a predefined threshold. Preferably, if the measured signal is above the predefined threshold the cross-terminal-feedback software program 43 proceeds to step 47 to send negative feedback information, and preferably, if the measured signal is below the predefined threshold the cross-terminal-feedback software program 43 proceeds to step 48 to send positive feedback information.

Alternatively, the cross-terminal-feedback software program 43 sends cross-terminal-feedback containing the value of the measured signal. It is appreciated that sending an accurate value of the measured signal is advantageous with respect to the ability of the base-station to optimally group the user-terminals, while sending a positive or negative feedback-information demands lower bandwidth.

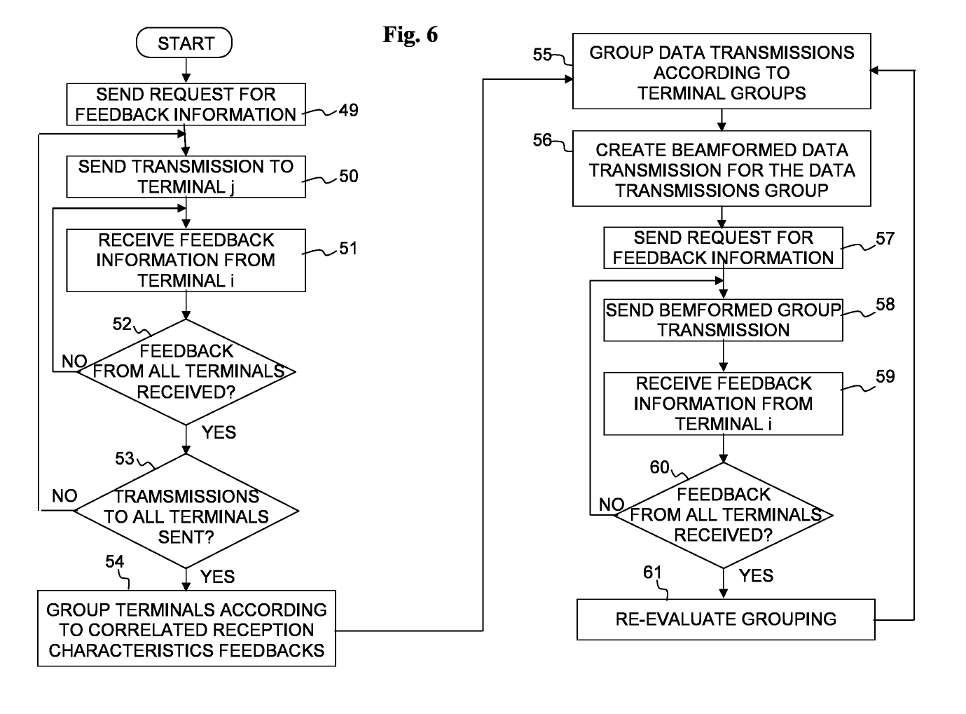

Reference is now made to FIG. 6, which is a simplified flowchart of grouping software program 43 according to a embodiment of the invention.

As seen in FIG. 6, the grouping software program 43 preferably starts in step 49 by sending a request for cross-terminal-feedback to all or some of the user-terminals 12 within the coverage areas of the base-station 11.

The grouping software program 43 then preferably proceeds to step 50 to send a transmission to one of the user-terminals 12, such as user-terminal 18 of FIG. 1. The grouping software program 43 then preferably proceeds to steps 51 and 52 to receive cross-terminal-feedback 20 from the other user-terminals 12 to which the request for cross-terminal-feedback was sent in step 49, such as user-terminals 19 of FIG. 1.

The grouping software program 43 then preferably proceeds to step 53 to repeat steps 50, 51 and 52 until the scanning of the user-terminals 12 is complete.

Then, the grouping software program 43 preferably proceeds to step 54 to create groups of user terminals 12 according to the collected cross-terminal-feedback 20. Preferably, each of the groups that the software program 43 creates contains a number of user terminals 12 that is equal or less than the maximum number of concurrent data streams that the base-station 11 can handle. Typically, the number of user terminals 12 in a group is equal or less than the number of antenna elements 16. Preferably, each group contains only user terminals 12 that sent cross-terminal-feedback 20 containing low channel correlation for all other members of that group.

The grouping software program 43 then preferably proceeds to step 55 to group data transmissions according to the terminal groups created in step 54. Then, the grouping software program 43 preferably proceeds to step 56 to create a beamformed data transmission for each group created in step 54. Preferably, The grouping software program 43 preferably proceeds to step 57 to send a request for cross-terminal-feedback 20, preferably to all user terminals 12. As the beamformed data transmissions are transmitted in step 58, the grouping software program 43 then preferably receives the cross-terminal-feedback 20, preferably from all user terminals 12 (steps 59 and 60). The grouping software program 43 then preferably proceeds to step 61 to evaluate and optionally recreate the groups of user terminals 12. According to the newly received cross-terminal-feedback 20. The steps 55 to 61 preferably repeat as necessary.

It is expected that during the life of this patent many relevant wireless devices and systems will be developed and the scope of the terms herein, particularly of the terms “SDMA” and “MIMO”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention.

1. A method for selecting a group of terminal devices from a plurality of terminal devices;
wherein said plurality of terminal devices is operative in a wireless communication network comprising at least one transmitter operative to communicating with a multiplicity of terminal devices from said plurality of terminal devices; and
wherein said transmitter is operative to transmit a beamformed plurality of concurrent data transmissions oriented at said selected group of terminal devices;
said method comprising the steps of:
measuring radiated power received by at least one of said terminal devices when a beamformed data transmission is sent by said transmitter to at least one another terminal device, wherein said measuring of radiated power forms channel correlation measurement;
reporting said channel correlation measurement to said transmitter; and
selecting, at said transmitter, said group of terminal devices from said multiplicity of terminal devices, wherein said group consists of terminal devices reporting low channel correlation with all other terminal devices in said group.

2. A method according to claim 1 wherein said beamformed plurality of concurrent data transmissions forms a group of beams, each directed towards at least one terminal device of a said selected group of terminal devices.

3. A method according to claim 1 wherein said transmitter is a base-station.

4. A method according to claim 1 wherein said channel correlation measurement comprises at least one of:
a measurement value of signal power received at said terminal devices when a beamformed data transmission is sent by said transmitter to at least one another terminal device;
an indication that said signal power received at said terminal devices when a beamformed data transmission is sent by said transmitter to at least one another terminal device is below a predefined value;
an indication that said signal power received at said terminal devices when a beamformed data transmission is sent by said transmitter to at least one another terminal device is above a predefined value;
an identification of said another terminal device; and
an identification of a time-frequency slot in which said data transmission was sent by said transmitter to said another terminal device;

5. A first terminal device operative in a wireless network, said wireless network comprising a base-station and a plurality of terminal devices, said first terminal device comprising:
a receiver unit operative to receive transmissions from said base-station;
a power measuring unit operative to measure radiated power received by said first terminal device to form power measurement; and
a transmitter unit operative to transmit reception characteristics feedback to said base-station;
wherein said reception characteristics feedback comprises at least one of:
a measurement of radiated power received at said first terminal device when said base-station transmits a beamformed transmission to at least one another terminal device;
an identification of at least one another terminal device for which said power measurement being less than a predefined value; and
an identification of a transmission slot for which said power measurement being less than a predefined value.

6. A base-station operative in a wireless network, said wireless network comprising a plurality of terminal devices, said base-station comprising:
a receiver unit operative to receive at least one reception characteristics feedback from at least one of said terminal devices; and
a transmitter unit operative to transmit beamformed data to said terminal devices according to said reception characteristics feedback;
wherein said reception characteristics feedback comprises at least one of:
a measurement of radiated power received at least one of said plurality of terminal devices when said base-station transmits a beamformed transmission to at least one another terminal device;
an identification of at least one another terminal device for which said measurement of radiated power being less than a predefined value; and
an identification of a transmission slot for which said measurement of radiated power being less than a predefined value.

7-10. (canceled)
